(19) United States
(12) Patent Application Publication
(10) Pub. No.: US 2013/0175216 A1
(43) Pub. Date: Jul. 11, 2013

(54) PHOSPHOROUS MITIGATION FOR GREEN FILTER BEDS

(71) Applicants: Jia Ma, Vancouver, WA (US); James H. Lenhart, JR., Portland, OR (US)

(72) Inventors: Jia Ma, Vancouver, WA (US); James H. Lenhart, JR., Portland, OR (US)

(73) Assignee: CONTECH STORMWATER SOLUTIONS INC., West Chester, OH (US)

(21) Appl. No.: 13/344,997

(22) Filed: Jan. 6, 2012

(51) Int. Cl. C02F 3/32; C02F 1/00

(52) U.S. Cl. 210/602; 210/170.03

(57) ABSTRACT

A stormwater filtration system suitable for treatment of stormwater runoff in a developed environment uses a treatment bay that includes a filtration bed with live plant matter and a plurality of functional layers. The filtration bed may include an adsorption layer or area that contains a phosphorus adsorptive granular media. In accordance with another aspect, the filtration system includes a layer of permeable pavers.

### TECHNICAL FIELD

This application relates generally to filtration systems and, more particularly, to phosphorous mitigation for stormwater systems incorporating live plant material (green filter beds) into the filtration process.

### BACKGROUND

Stormwater runoff can be a form of diffuse or non-point source pollution. It can entrain pollutants, such as trash and debris, sediment, organic matter, heavy metals, pathogens, and organic toxins, and flush them into receiving water bodies. As a consequence, natural bodies of water that receive stormwater may also receive pollutants.

In an effort to address the environmental problems posed by polluted stormwater, traps and filters for stormwater have been developed. Stormwater filtration cartridges, such as those described in U.S. Pat. Nos. 5,707,527, 6,027,639, 6,649,048, and 7,214,311, pull stormwater through a filtration bed that removes pollutants prior to discharge into a receiving water body. Improvements to such cartridges have produced highly effective filters that allow for significant throughput, as described in the references cited above, while also allowing for easy installation and replacement of the modular cartridge units.

Another known method of stormwater filtration involves the installation of horizontally-disposed filtration beds using a mixture of materials often including organic compost. Stormwater runoff directed into these beds is filtered in an action not unlike natural soil. Live plant material is sometimes added to take advantage of its pollutant uptake as well as for aesthetic value. While mixtures for these filtration beds can be developed that accommodate a higher throughput of stormwater than natural soil, the level of throughput is still limited by the area of the bed and nature of the filtration bed material. Additionally, in areas where rainfall is sporadic, the stormwater received may not be sufficient to maintain the live plant matter therein.

Biofiltration in a filtration bed combines physio-chemical filtration with biological processes to maximize the removal of stormwater pollutants. Biomedia, as a key driver of biofiltration performance, typically includes a specific blend of soil including inorganic components, such as sand, pumice, zeolite and perlite, and organic components, such as peat, compost and mulch, etc. Contaminated stormwater is conveyed to the biomedia surface where it flows directly into or ponds and subsequently percolates through the biomedia. The particulate pollutants are filtered at the biomedia surface as well as within the biomedia bed. The addition of organic components such as compost and peat to the media blend allows the system to adsorb and ion exchange with dissolved pollutants especially dissolved metal ions. Indigenous or ornamental vegetation planted on biomedia adds benefits of nutrient uptake, increased evapotranspiration, promotion of beneficial bacterial growth, improved aesthetics and increased hydraulic conductivity.

However, recent studies show that conventional biomedia may exhibit unacceptable phosphorus (P) leaching due to the decomposition of natural organic components in the biomedia which elevate the effluent phosphorus concentration and result in inferior removal of phosphorus as well as the ability to sequester phosphorus contained in the filtered runoff. In addition, most of the traditional biomedia have been devised to operate at a low infiltration rate such as a few inches per hour or even less. A larger biofiltration treatment system is required to handle the low infiltration rate and a larger system is less desirable in the denser urban environment.

It would be desirable to develop a treatment system using a filtration bed including live plants in combination with biomedia which releases minimal or zero residual phosphorus as well as providing long term effectiveness in the removal of phosphorus.

### SUMMARY

The present application is directed to a stormwater filtration system that includes a filtration bed containing a plurality of functional layers. In accordance with one aspect, the filtration bed includes an adsorption layer or area that contains a phosphorus adsorptive granular media. The media may be expanded perlite thermally impregnated with at least one active material. In a particularly useful embodiment, the active material is activated alumina, which facilitates removal of phosphorus from the stormwater.

In accordance with another embodiment, the present application describes a stormwater filtration system containing an adsorption layer in a filtration bed wherein the system also includes a first or primary treatment bay with live plant matter in the filtration bed, and a second overflow or secondary treatment bay that receives and treats stormwater that exceeds the capacity of the first treatment bay.

In a further aspect, a stormwater filtration system is described wherein the system includes a filtration bed having a plurality of layers wherein the uppermost layer comprises permeable pavers.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 shows one embodiment of a filtration system from above;

FIG. 2 is a side elevation view of the system of FIG. 1;

FIG. 3 is a side elevation view of a filtration system;

FIG. 4A shows a filtration system containing permeable pavers from above;

FIG. 4B is a perspective view of the filtration system of FIG. 4A;

FIG. 5A is a top-down view of a filtration system in accordance with another aspect; and

FIG. 5B is a side elevation view of the filtration system of FIG. 5A;

FIG. 6A is a perspective view of filtration system in accordance with another aspect;

FIG. 6B is a side elevation view of the filtration system of FIG. 6A;

FIG. 7 is a side elevation view of a filtration system in accordance with another embodiment; and

FIG. 8 is a side elevation view of another embodiment of a filtration system.

### DETAILED DESCRIPTION

The present application is directed to a stormwater filtration system having a filtration bed with live plant matter therein. In accordance with some aspects, the filtration bed comprises a filtration layer overlying an adsorption layer. In accordance with certain aspects, the adsorption layer comprises a phosphorus adsorptive granular media to facilitate removal of phosphorus. In accordance with other embodiments, the stormwater filtration system comprises a filtration bed having a top layer of permeable pavers.

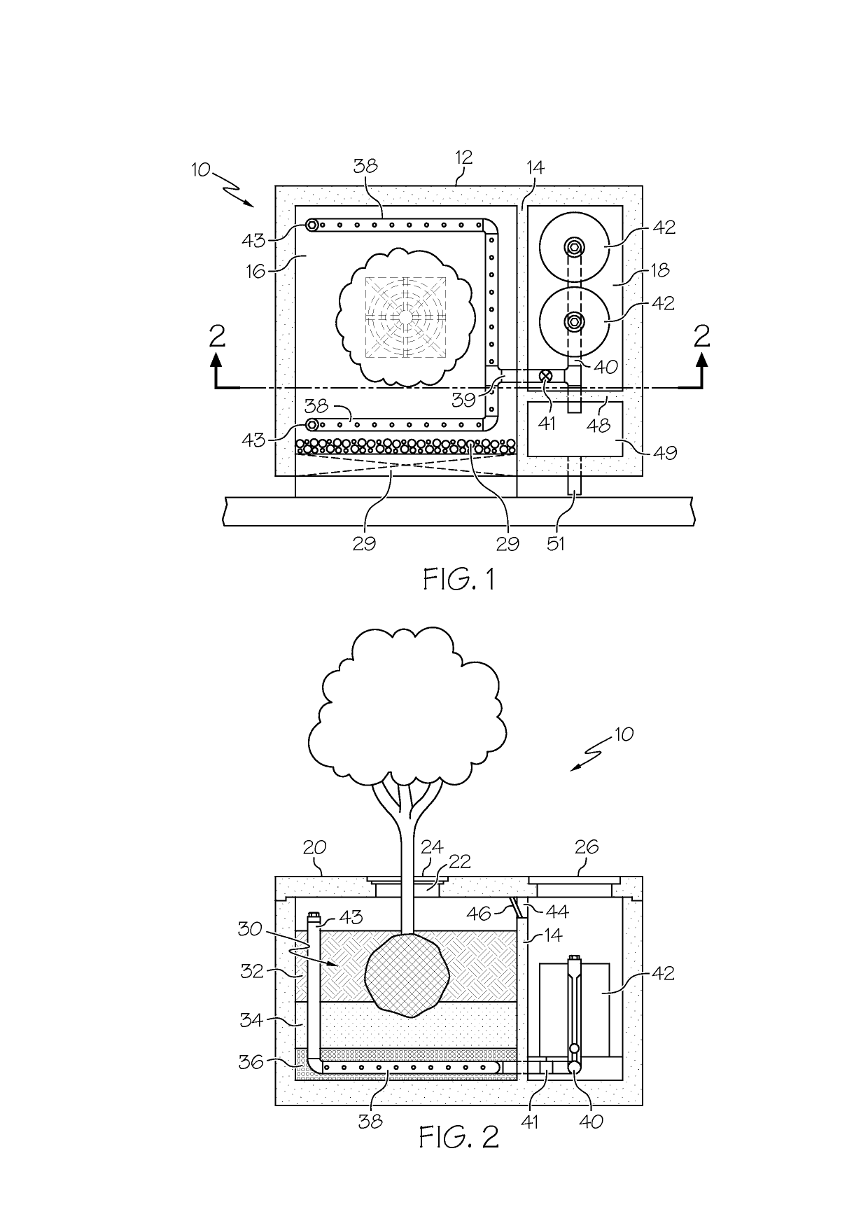

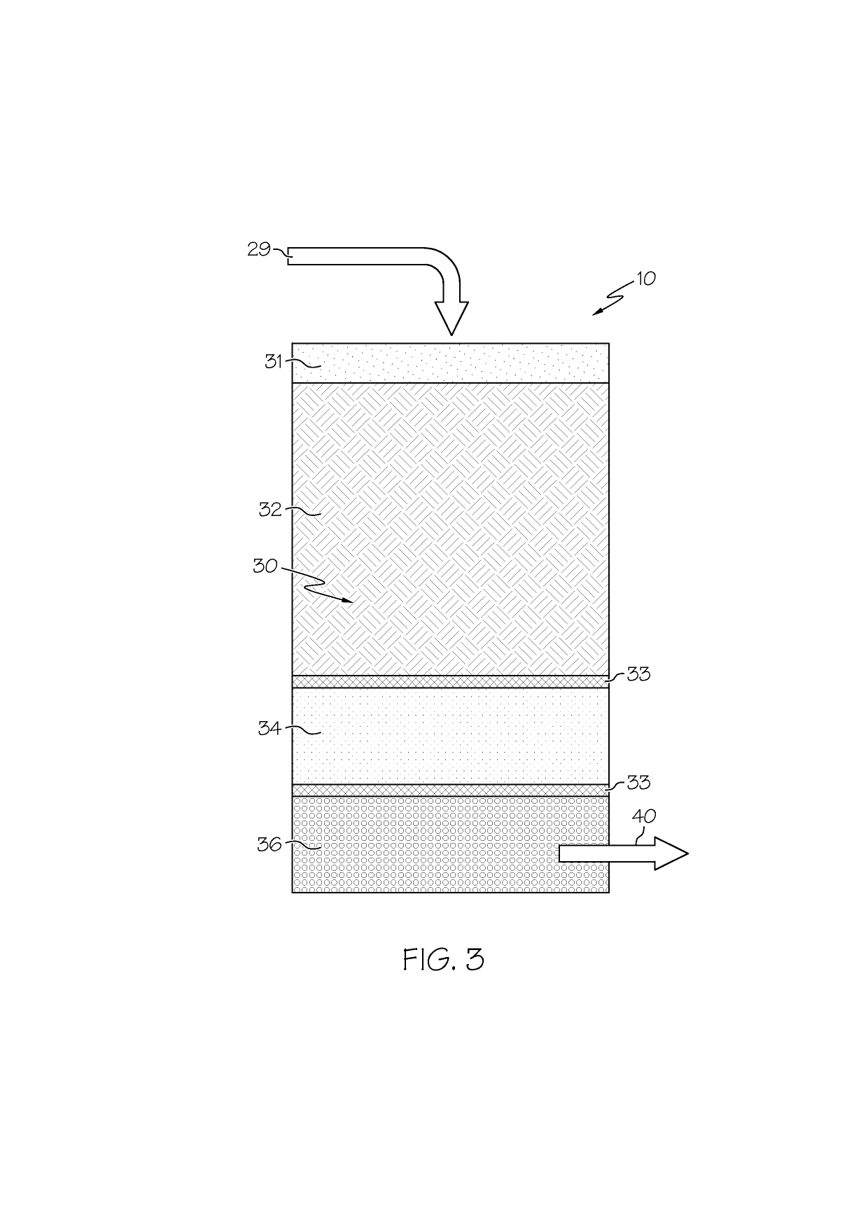

In accordance with a particular embodiment shown in FIGS. 1 and 2, a filtration system 10 is provided in a concrete vault 12 that has an internal vertical wall 14 dividing the vault into a primary treatment bay 16 and an overflow or secondary treatment bay 18. A top wall 20 of the unit is also formed of concrete. Other materials could be used to form the vault, and the two bays could be formed as separate structures or vaults placed side-by-side and connected by corresponding adjacent wall openings and/or piping.

The primary treatment bay side of the top wall includes an opening 22 and associated tree ring 24 through which the trunk or stem of a tree or herbaceous plant extends. A manhole or hatch 26 above the overflow treatment bay gives access to the filtration means located therein. Dimensions for the vault could vary as needed. The embodiment shown also provides an overflow treatment bay 18 that utilizes a suitable stormwater filter cartridge 42, such as the StormFilter product available from Contech Stormwater Solutions, Inc. of West Chester, Ohio, and described in U.S. Pat. No. 7,214,311 (the contents of which are hereby incorporated by reference). Other possible cartridges that could be used include the Perk Filter available from Kristar Enterprises Inc. of Santa Rosa, Calif. or the CDS or MFS filtration cartridges also available from Contech Stormwater Solutions, Inc. It is also recognized that the overflow treatment bay 18 could utilize other forms of stormwater filtration devices, including non-cartridge type devices. Upflow type filters could also be used. In certain embodiments, the filtration means of the overflow treatment bay is readily replaceable, as is the case with the cartridge-type filters.

As shown, the filtration system 10 is of a size and structure suitable for placement in an urban environment, such as along a street or parking area to receive surface runoff or next to a building to receive the roof runoff. The vault prevents accumulated stormwater from destructively interfering with adjacent urban systems, and the generally self-contained configuration allows for easy placement as part of existing stormwater drainage solutions. The filtration system may be modified in configuration, structure, or size to accommodate the specific stormwater treatment needs of a target area without deviating from the invention as described and claimed herein.

Referring again to FIGS. 1 and 2, water flows into the primary treatment bay via a curb inlet opening 29 and onto a band of rip-rap 28 to reduce water speed and erosion. In one embodiment, the tree is planted within a multi-layer filtration bed 30 in the treatment bay. As shown, the filtration bed 30 includes in order from top to bottom, a filtration layer 32, an adsorption layer 34 and a drainage layer 36. Drainage layer 36 contains and covers a perforated pipe or pipe system 38 that collects water that has filtered through the bed.

The pipe system 38 includes an outlet segment 39 that runs through the dividing wall 14 into the secondary treatment bay 18 and joins with the outlet conduit 40, at a downstream side of the cartridges 42, for subsequent flow to the outlet of the vault. An outlet control valve 41 or flow restriction orifice is positioned to control flow through the primary treatment bay to a desired flow rate according to applicable regulatory requirements. The pipe system 38 also includes one or more cleanouts 43 that extend upward above the top of the bed for accessibility.

The dividing wall 14 is formed to include a secondary path 44 to the secondary treatment bay. The secondary path may be a pathway at or near the top of the wall. The pathway may include an inclined screen 46 (e.g., made of stainless steel with aperture size of about 5 mm). Excessive flows into the primary treatment bay (i.e., flows that exceed the treatment capacity of the primary treatment bay) will result in an overflow into the secondary bay 18, where the overflow stormwater moves through one or more filter cartridges 42 for treatment. The water treated by the cartridges 42 meets the water treated by the primary treatment bay 16 downstream from both treatment means for mutual outflow. A bypass weir 48 is located in the secondary treatment bay 18 such that flows into the secondary treatment bay 18 in excess of the flow capacity of the filter cartridges 42 will pass directly to an outlet bay 49 and then to the vault outlet 51. In the illustrated embodiment the outlet conduit 40 delivers the treated water to the outlet bay 49.

It is recognized that instead of, or in addition to the tree, other live plant material could be used, including grasses and shrubs. The opening 22 and associated tree ring 24 may be replaced by another opening and configuration suitable for the live plant material used. Another option would be to provide the primary treatment bay without any live plant material. For example, a rock surface or layer of permeable pavers, such as those commercially available from Xeripave LLC, could overlay the filter bed, particularly where irrigation is unavailable or undesirable. This plant free embodiment could still utilize a water reservoir and wicking apparatus to reduce runoff volumes and encourage biotic activity in the soil.

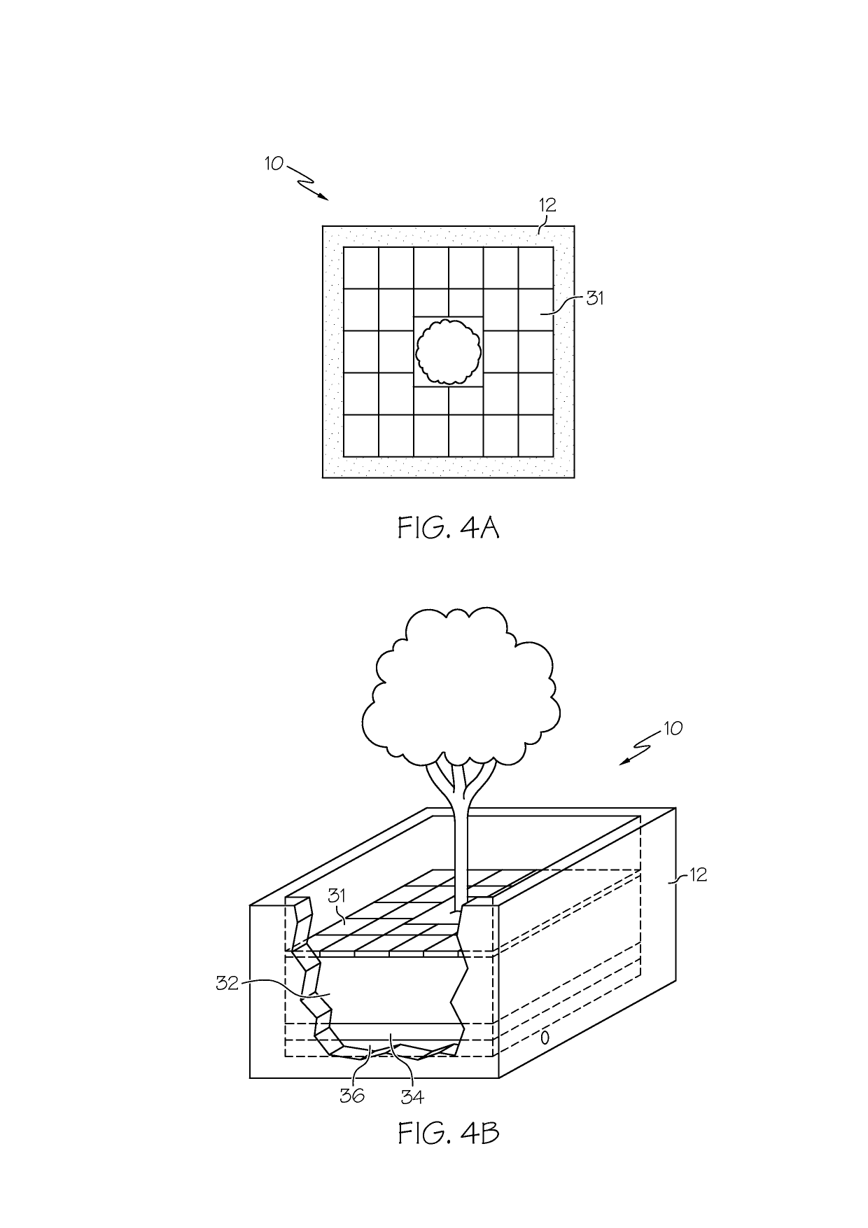

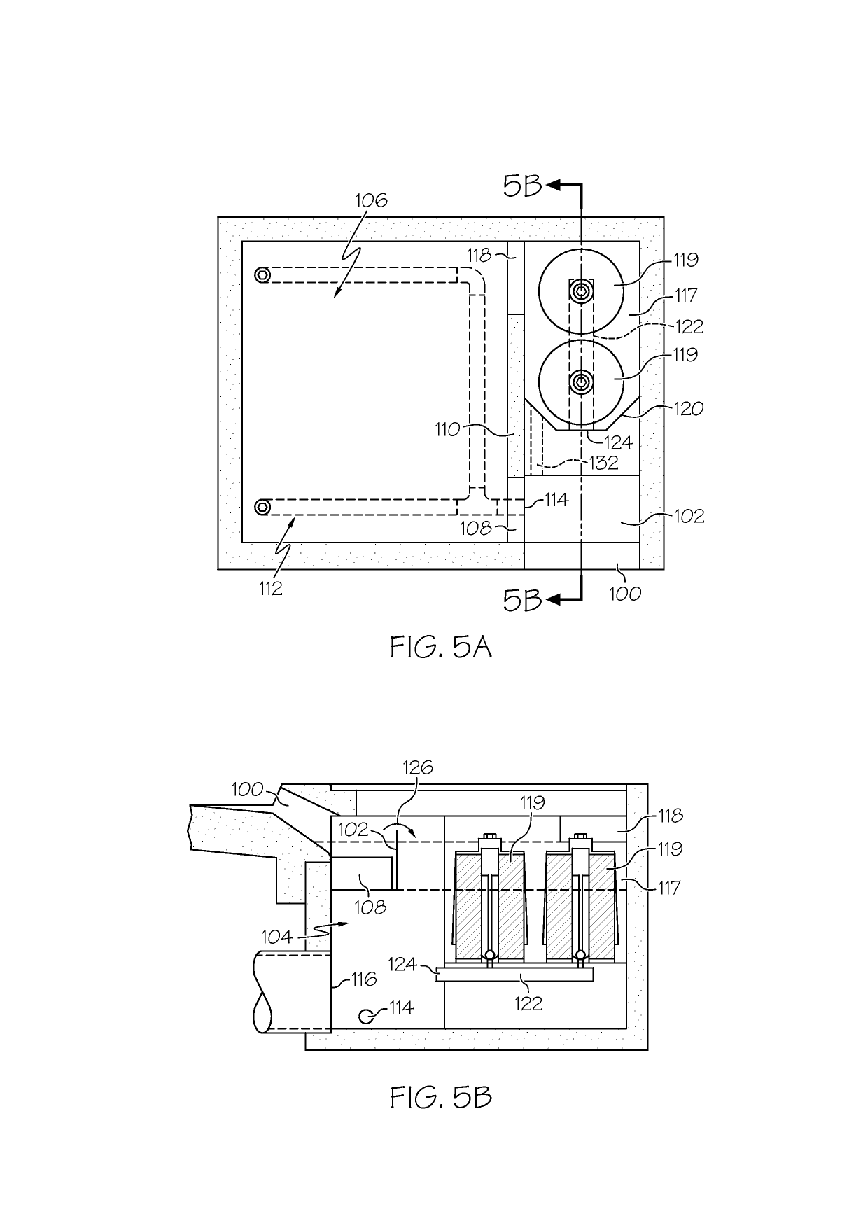

FIG. 3 illustrates a simplified version in accordance with one aspect highlighting the layers of the filtration bed. As shown, the stormwater treatment system 10 includes an inlet opening 29 conveying stormwater to the filtration bed 30. The filtration bed 30 in this embodiment includes, in order, from top to bottom, a permeable paver layer 31, a filtration layer 32, adsorption layer 34 and drainage layer 36. A permeable membrane 33, such as a geotextile fabric, may be located between any or all of the layers of the filtration bed. Stormwater filtered through the filtration bed is received by and delivered out of the system through outlet conduit 40. The filtration bed may also include live plant matter as shown in FIGS. 4A and 4B which illustrate other views of a stormwater treatment system 10 containing permeable pavers 31. In FIGS. 4A and 4B the top wall of the vault and associated tree ring have been left out for clarity. The adsorption layer 34 contains a phosphorus adsorptive granular media and in certain cases the media comprises expanded perlite thermally impregnated with at least one active material, such as activated alumina.

The permeable paver layer, when present, is typically the uppermost layer of the filtration bed and may be directly on top of the adjacent layer as shown in FIGS. 3 and 4B or the two layers may be separated by a permeable membrane. The permeable pavers allow for flow through of water and typically have an initial permeability of not less than 10, more particularly not less than 25 gallons per minute per square foot. Particularly useful pavers are available from Xeripave LLC under the name Xeripave™ pervious pavers. Although the embodiments illustrated in FIGS. 3 and 4B show permeable pavers in combination with a filtration bed having a particular construction, it should be appreciated that the permeable pavers can be utilized in combination with a wide variety of layers that may make up the rest of the filtration bed. For example, the pavers may be used in conjunction with a single layer or multiple layers that are not particularly limited to any specific function or design. In accordance with certain aspects, the permeable paver layer helps to hold down the material of the bed (e.g., the organic and inorganic materials of the bed and including mulch if present) to prevent it from eroding or floating during water events. Larger items become trapped atop the permeable paver layer and may be readily removed without disturbing the bed.

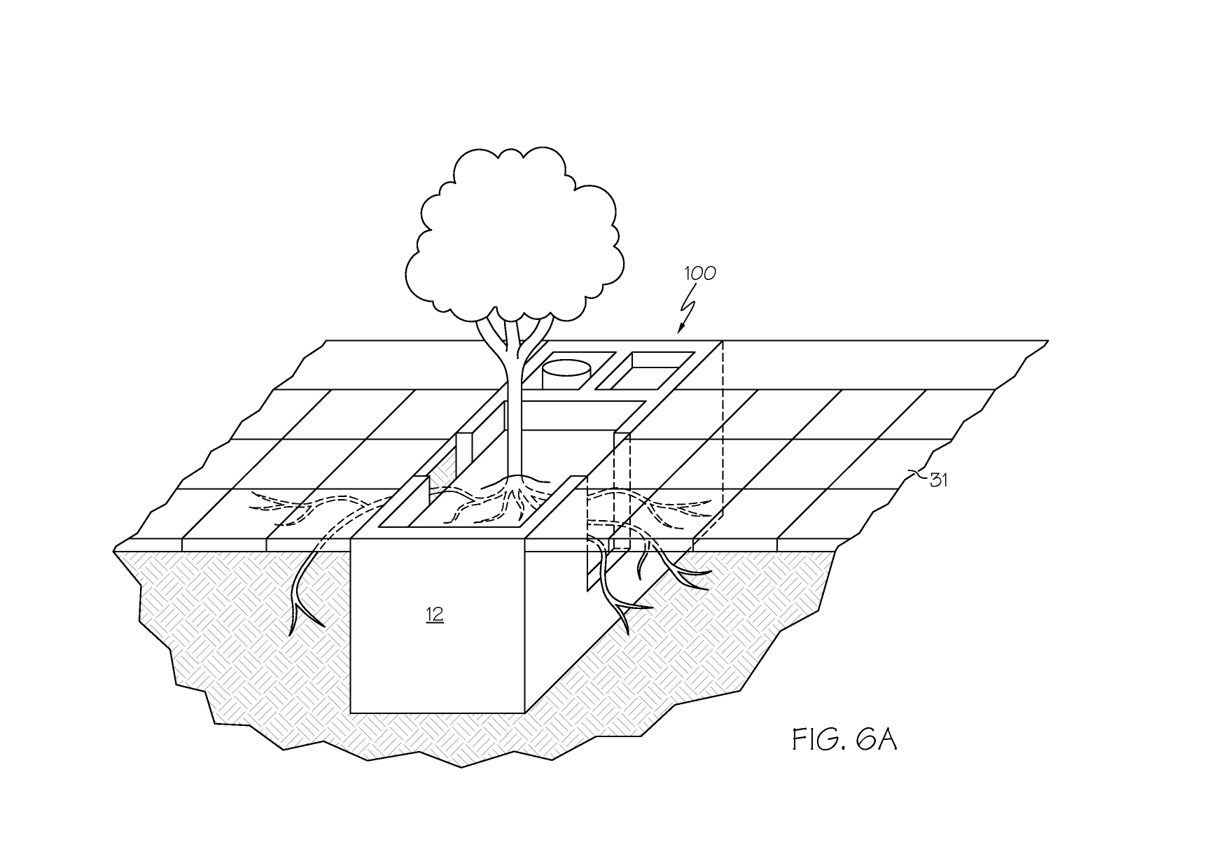

Referring to FIGS. 5A-5B, another embodiment of the basic stormwater system is shown in which stormwater enters the vault unit through an inlet opening 100 into an inlet tray or compartment 102 above the outlet in the outlet bay 104. The water leaves the tray and flows laterally into the primary treatment bay 106 and the filtration bed via opening 108 in wall 110. Although not shown, treatment bay 106 typically contains the filter bed and live plant material described in the previous embodiments. Water traveling downward through the primary treatment bay bed enters a pipe system 112 and is directed into the outlet bay 104 though primary bay outlet 114. Once in the outlet bay water can exit the unit via outlet opening 116. Water that enters the primary treatment bay in excess of its treatment capacity rises and spills into the secondary treatment bay 117 via overflow opening 118 to pass to the filter cartridges 119. The secondary treatment bay is sealed from the outlet bay by a metal (or other) wall 120, except that water passing through the filters enters a pipe 122 and then flows to the secondary bay outlet 124, which flows into the outlet bay 104. If the water inflow to the unit exceeds the combined capacity of both the primary treatment bay and the secondary treatment bay, the water will rise higher in the primary treatment and cause the water level in the inlet tray 102 to rise. The inlet tray 102 is configured with an overflow path 126 directly into the lower portion of the outlet bay 104, and water can flow over a top of the tray directly into the outlet bay for exiting the unit without passing through either the primary treatment bay or the secondary treatment bay. The lower edge of the overflow path 126 is above the lower edge of the overflow opening 118 in the wall 110.

In one example, the inlet tray or compartment 102 may be formed as a metal tray structure mounted to the wall of the vault. The floor component 130 may be removable such that, during installation, and prior to completion of the unit, the floor component may be left out of the unit such that stormwater entering the inlet compartment proceeds directly down to the outlet 116 of the outlet bay 104 without entering the primary treatment bay 106. Once the unit is ready it can be brought online by installing the floor structure.

In an alternative arrangement, the unit shown in FIGS. 5A and 5B could be modified such that the overflow opening 118 in the wall 110 is eliminated (i.e., no direct overflow path from bay 106 to bay 117) and an overflow path 132 directly from the inlet compartment 102 to the bay 117 is provided. In such an arrangement, the incoming water in excess of the primary treatment bay flow capacity would not enter the primary treatment bay in order to travel to the secondary treatment bay.

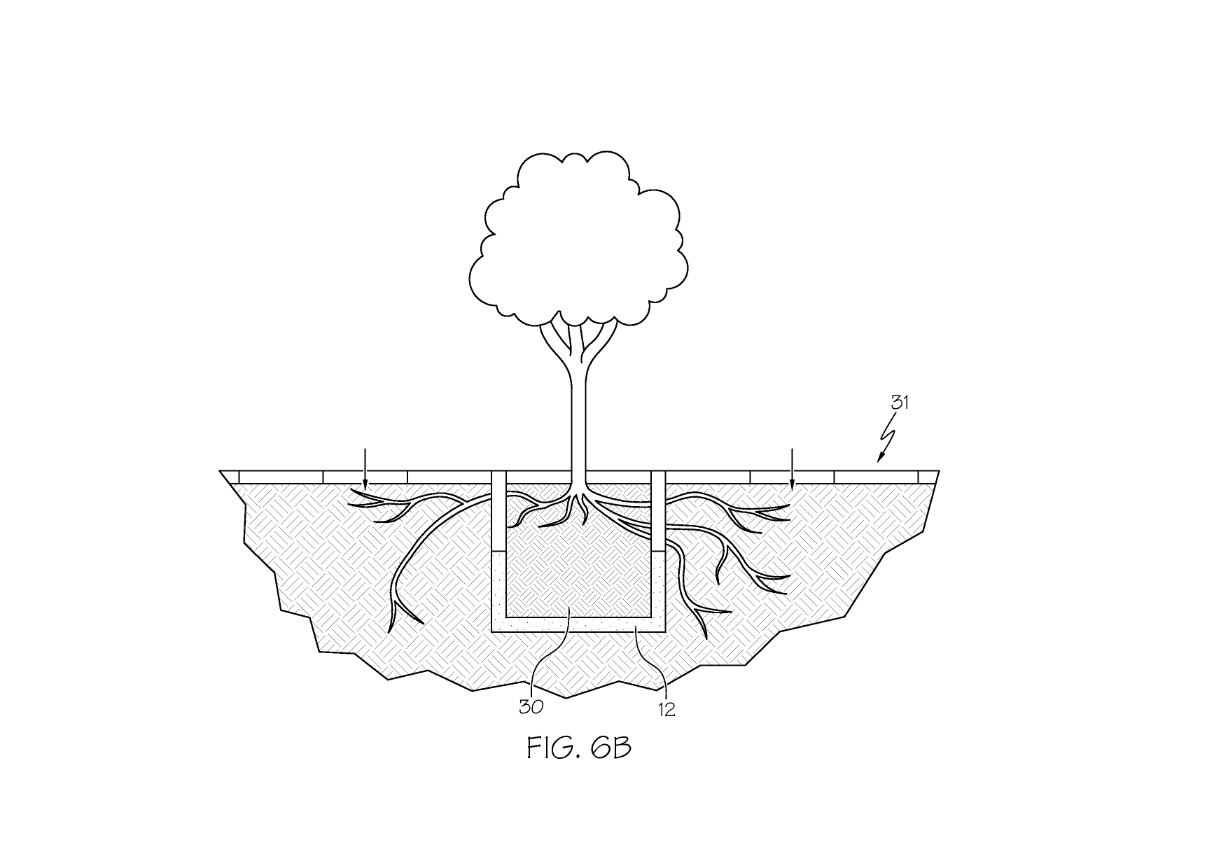

Referring to FIGS. 6A-6B, another embodiment of the basic stormwater system is shown in which stormwater enters the vault unit 12 through an inlet opening 100 and water also enters the vault 12 and surrounding area through porous pavers 31. The porous pavers 31 can be used in conjunction with the filter bed box structure to provide for increased soil and root growth which can occur outside of the box and filtration bed 30 into the adjacent soils. Openings in the box will allow plant roots to move laterally to increase their water supply and increase water use and nutrient uptake. The porous pavers 31 can be positioned so as to form a walkable sidewalk surface around the stormwater system as well as being optionally configured to store a volume of water beneath the surface for continued treatment.

In accordance with another aspect, the present application describes a stormwater system including a vault forming a bay having a filtration bed with live plant matter therein, an inlet for delivering stormwater into the bay, an outlet flow system in a lower part of the bay for receiving stormwater filtered through the filtration bed and delivering the filtered stormwater out of the bay, and an absorption area comprising a phosphorus adsorptive granular media. The absorption area may be granular media provided as a layer in the filter bed or granular media in a container. The container may be removable so as to facilitate replacement of media.

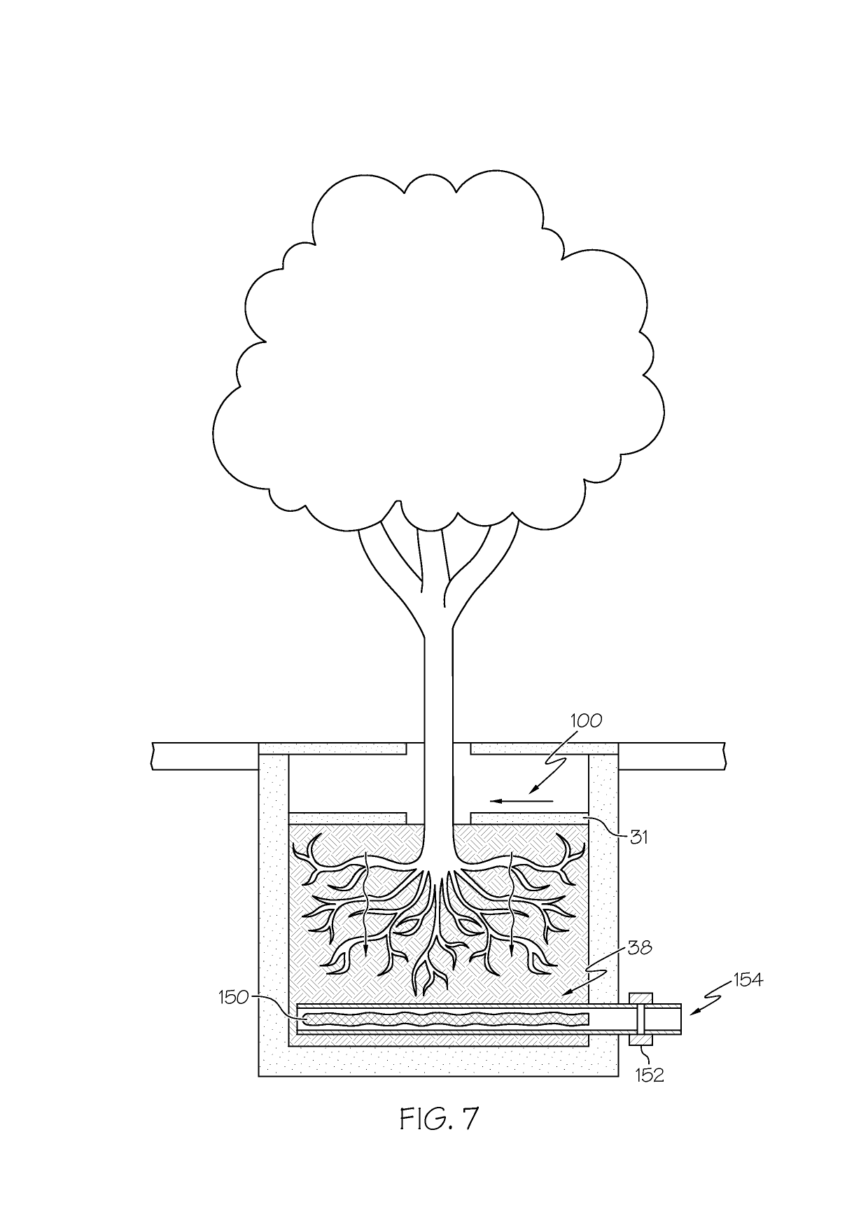

FIG. 7 illustrates another embodiment of the disclosed stormwater system wherein the stormwater enters vault unit 12 through an inlet opening 100 and flows over and through the permeable pavers 31 to enter the filtration bed. The water flows through the filtration bed to be collected by perforated pipe or pipe system 38. The perforated pipe or pipe system 38 in this embodiment contains a removable porous sock 150 containing phosphorus adsorptive granular media which adsorbs phosphorus from the stormwater. The pipe system 38 includes an outlet segment that runs through the wall and joins with the outlet conduit 154 through a coupler 152 which provides access to the removable porous sock for change out of the porous sock and/or the media contained therein.

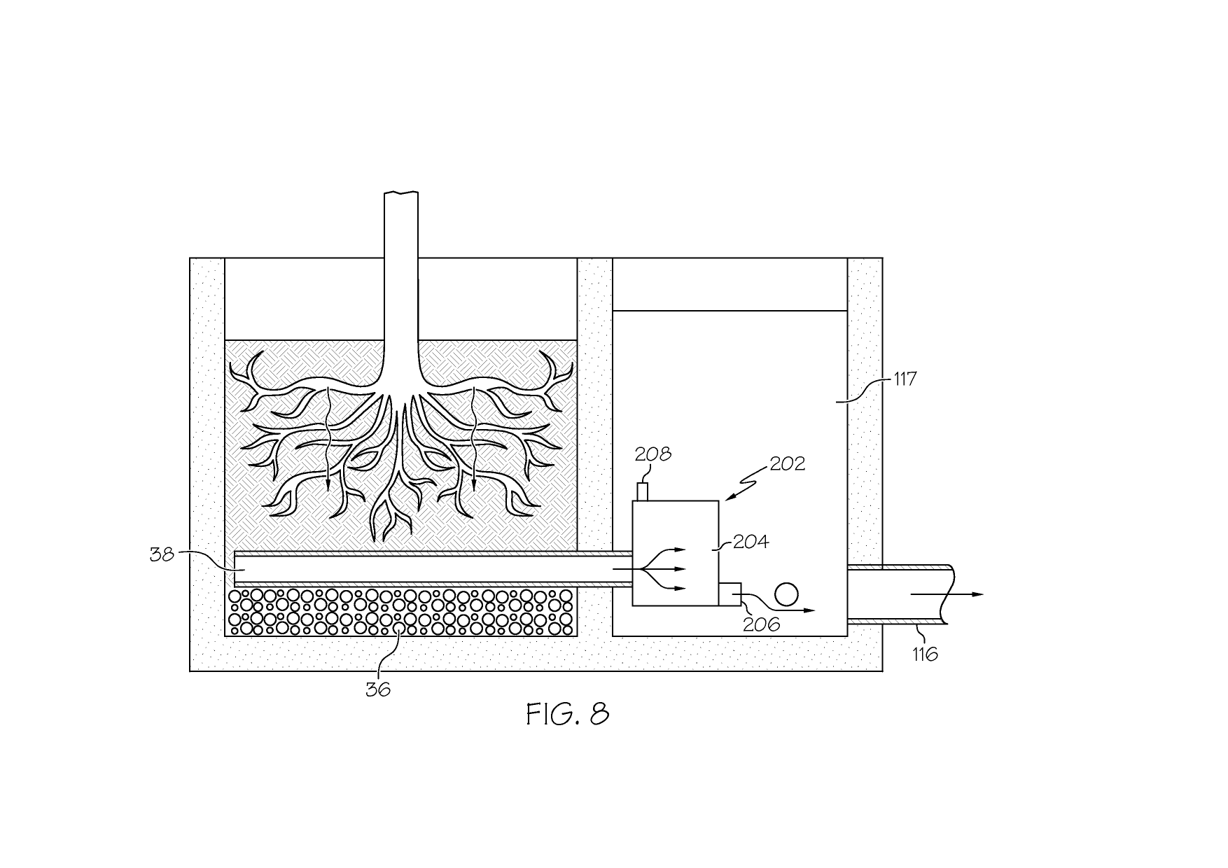

FIG. 8 illustrates another embodiment of the disclosed stormwater system wherein the stormwater flows over and through the filtration bed to be collected by perforated pipe or pipe system 38 over drainage layer 36. The perforated pipe or pipe system 38 in this embodiment includes an outlet segment that runs through the wall into the secondary treatment bay 117 and feed the water into a removable media polishing vessel 202 that contains therein phosphorus adsorptive granular media 204 which adsorbs phosphorus from the stormwater. Treated water exits from the removable media polishing vessel 202 through control orifice 206 which regulates flow of the water through vessel 202. Media polishing vessel 202 includes a vent 208 to prevent pressure buildup. Removable media polishing vessel 202 can be accessed as needed to change out the vessel and/or the media contained therein.

Filtration Bed Composition

The filtration layer 32 may be of any depth suitable for the particular application. Typically, the filtration layer 32 has a depth of about 6-30 inches. Biomedia or media mixture in the filtration layer typically comprises a mixture of coarse inorganic components such as sand, pumice, zeolite and perlite, and organic components such as peat, compost and mulch etc. In accordance with certain embodiments, the organic components may account for about 8% or greater and typically less than 25% based on the volume of the filtration layer. The inorganic components typically occupy the remaining volume (about 75% to 92%).

In accordance with certain aspects, all of the inorganic and organic ingredients are in the form of pellets and/or granules. Pellets or granules facilitate the hydraulic conductivity and therefore the filtration rate. In accordance with some aspects, greater than about 90% of inorganic granules based on mass pass through standard sieve of ½″ and are retained by standard sieve No. 14. In other words, the majority of the inorganic granules are finer than ½″ and coarser than 1.4 mm. In addition in some embodiments, 50% of the inorganic granules based on mass (D₅₀) are retained by standard sieve No. 5, indicating the average granular size of 4 mm or coarser. Since organic granules typically only account for a much smaller percentage (8%-25%) based on the volume of the filtration layer, their effect on the overall particle size distribution of the biomedia filtration layer is less than the effect of inorganic components. Nonetheless, in accordance with some embodiments, 90% of the organic granules based on mass typically are sized between about 0.5 mm and 9.5 mm with D₅₀ typically in the range of about 1 mm and 4 mm.

Specific examples of the media mix that may be used to form filtration layer 32 include mixtures containing about 7-13% by volume of pelletized leaf compost, about 60-80% by volume pelletized pumice, and about 10-25% by volume sand. In accordance with certain embodiments, the pelletized leaf compost is CSF leaf media, which is made exclusively of composted, fallen deciduous leaves in granulated form, and is available from Contech Stormwater Solutions, Inc., of West Chester, Ohio. In accordance with another embodiment, the media mix may comprise about 85-95% by volume of coarse sand and about 5-15% by volume peat granules. The filtration layer 32 may also include a water absorbent crystalline material, which is typically present in an amount of less than 1% by volume.

The adsorption layer 34 may have any depth suitable for a particular application. In accordance with one embodiment, the adsorption layer typically has a depth of 3-6 inches and is composed of phosphorus adsorptive granular media such as PhosphoSorb®, which is a lightweight media partially composed of perlite and activated alumina. In accordance with certain embodiments, greater than 90% of the adsorptive granules in the adsorption layer based on mass pass through standard sieve ¼″ and are retained by standard sieve #14. In other words, the majority of the pellets are finer than ¼″ and coarser than 1.4 mm. In accordance with one embodiment, the average size of the adsorptive granules may be about 0.5 mm to about 12.5 mm and in certain cases about 4 mm.

Examples of particularly useful phosphorus adsorptive granular media are described in U.S. Pat. App. Pub. No. 20100038327, the contents of which are hereby incorporated by reference. The '327 publication describes a light-weight adsorptive filtration media comprising thermally treated expanded perlite or thermally treated expanded perlite impregnated by at least one active material capable of removing dissolved constituents or contaminants from an aqueous composition. Expanded perlite pellets (typically ranging in size of about 2.0 mm-25.0 mm with a bulk density of 2 to 25 lbs/ft³ or 32 to 400 kg/m³) can be thermally processed to shrink them with marginal weight loss. The term “thermally treated expanded perlite” refers to expanded perlite that has been reduced in size during a high temperature treatment. Typically, the temperature treatment of the expanded perlite pellets results in a reduction of volume from about 20% to about 70%, more particularly from about 40% to about 60%; and in accordance with certain embodiments, the perlite pellets are reduced to about 50% of the starting volume for the untreated expanded perlite. The thermally treated perlite typically exhibits improved crush strength and reduced amount of fines on the surface of perlite pellets as compared to the untreated media. The resulting perlite pellets are still porous and light-weight with a bulk density of about 4 to 50 lbs/ft³ or 64 to 800 kg/m³, more particularly about 15 to 35 lbs/ft³ or 240 to 560 kg/m³.

The expanded perlite may be thermally impregnated with at least one active mineral such as calcium, magnesium, aluminum or iron having the capacity to remove dissolved phosphorus from an aqueous composition. Examples of active materials that may be used include calcium, aluminum, iron and magnesium. Also having the capacity to react with and remove dissolved phosphorus, other uncommon active minerals could be used such as barium, copper, lead, etc. The sources of the various elements are not particularly limited and may be selected from salts of the active materials. Specific examples of starting materials that may be used to incorporate aluminum, iron, calcium or magnesium include activated alumina, Al₂O₃, Al(OH)₃, AlO(OH), Fe₂O₃, FeO(OH), Fe(OH)₃, CaCO₃, Ca(C₂H₃O₂)₂, Ca(HCO₃)₂, Ca(OH)₂, CaSiO₃, CaO, MgCO₃, Mg(C₂H₃O₂)₂, Mg(HCO₃)₂, Mg(OH)₂, MgSiO₃ and MgO. The starting material used in forming a slurry with the perlite pellets may be the active form of the material (as with calcium oxide) or, as with the calcium carbonate, may be a relatively inactive form of the material that can be converted to an active form during the heating process. In accordance with a more particular aspect, an active mineral such as a calcium compound or activated alumina is impregnated into expanded perlite pellets by heating such that the calcium/aluminum mineral diffuses into the pores of the perlite.

The drainage layer 36 may have any depth suitable for a particular application. Drainage layer 36 typically has a depth of 3-6 inches and contains a coarse inorganic component such as pea gravel. Typically, greater than 90% of these drainage granules based on mass should pass through standard sieve ½″ and be retained by standard sieve #8. In accordance with certain aspects, the average size of the granules in the drainage layer is about 7 mm.

Other variations in the make-up of the bed 30 are possible and contemplated, including beds with more or fewer layers, beds of uniform composition throughout their depth, and beds that utilize other materials.

In another aspect, a stormwater filtration system including live plant material and a filter bed with a phosphorus adsorptive media may involve multiple vault chambers, or a larger vault with multiple bays, designed to extend over a larger area or footprint. Examples of other stormwater systems that may be modified to include the filter bed described herein include those systems described in U.S. Pat. No. 6,277,274 to Coffman and U.S. Pat. App. Pub. Nos. 2009/0255868 to Allen, II et al., 2010/0206790 to Holtz, 2011/0147303 to Allard and 2011/0186492 to Holtz, the contents of these patent documents are hereby incorporated by reference.

Depending on the nature of the filtration system, the walls separating the primary and secondary vault chambers may include openings to accommodate the root system, or may be partially or entirely absent. The vault chambers may be part of a tandem structure or may be distinct and modular in construction. In one embodiment, the same shape and material is used for each vault chamber, both primary and secondary, with differing top wall coverings to accommodate the differing live plant matter in the filtration beds. In another embodiment, the primary vault chamber may be structurally distinct from the secondary vault chamber.

Any of the structures disclosed above may be included in the primary and secondary vault chambers shown here, including the inlet and outflow means, the secondary treatment bay, etc. The filtration beds may be of similar composition or may differ between the primary and secondary vault chambers. A variety of perforated pipe configurations may connect the chambers.

The following example is representative of certain aspects of the present invention, but is in no way limiting as to the scope of the invention.

### Biomedia Filter Bed Example 1

TABLE 1

| Layer | Media composition |
|---|---|
| Filtration | Organic granules: 10% (based on volume), D₅₀ = 2 mm |
| (21″) | Inorganic granules: 90% (based on volume), D₅₀ = 4 mm |
| Adsorption (3″) | PhosphoSorb: D₅₀ = 4 mm |
| Drainage (3″) | Pea gravel: D₅₀ = 6.5 mm |

The biomedia as set forth in Table 1 provided +98% solids removal in one study. The same biomedia provided 60% P removal in one study and +80% P removal in another study. All of the above mentioned testing results were obtained at high infiltration rate of 100 inches per hour.

It is to be clearly understood that the above description is intended by way of illustration and example only and is not intended to be taken by way of limitation. For example, while the primary embodiment shown and described above includes a vault structure in which the primary treatment bay includes a solid bottom wall, it is recognized that the solid bottom wall could be made porous, or with one or more openings, or even eliminated in applications where it would be desirable to have some treated water infiltrate into the ground below the device. The outlet bay could similarly be formed to allow such infiltration. Other variations are possible.

### Biomedia Filter Bed Example 2

In this configuration the Phosphosorb® media is deployed in a filter sock that is placed inside the drainage manifold. This allows for the periodic replacement of the media, should it become saturated with the target pollutant before the removal of the entire upper filter bed is required due to occlusion with solids or event necessitating bed removal. In this configuration the under drain may be designed to fully drain between storms to maintain aerobic conditions.

What is claimed is:

1. A stormwater filtration system comprising:
a vault forming a bay having a filtration bed with live plant matter therein, an inlet for delivering stormwater into the bay, an outlet flow system in a lower part of the bay for receiving stormwater filtered through the filtration bed and delivering the filtered stormwater out of the bay, wherein the filtration bed comprises a filtration layer overlying an adsorption layer wherein said adsorption layer comprises a phosphorus adsorptive granular media.

2. The stormwater filtration system of claim 1, wherein the phosphorus adsorptive granular media comprises expanded perlite thermally impregnated with at least one active material.

3. The stormwater filtration system of claim 2, wherein said active material comprises activated alumina.

4. The stormwater filtration system of claim 2 wherein the average particle size of the phosphorus adsorptive granular media is about 0.5 mm to about 12.5 mm.

5. The stormwater filtration system of claim 1 wherein the filtration layer comprises a media mixture comprising inorganic components and organic components wherein the inorganic components account for a majority of the volume of said filtration layer.

6. The stormwater filtration system of claim 5 wherein the inorganic components are selected from the group consisting of sand, pumice, zeolite, perlite and combinations thereof.

7. The stormwater filtration system of claim 5 wherein the organic components are selected from the group consisting of peat, compost, mulch and combinations thereof.

8. The stormwater filtration system of claim 5 wherein the organic and inorganic components are in the form of pellets or granules.

9. The stormwater filtration system of claim 5 wherein the media mixture comprises pelletized leaf compost, sand, zeolite and pumice.

10. The stormwater filtration system of claim 9 wherein the media mixture comprises about 7-13% by volume of pelletized leaf compost, about 60-80% by volume pelletized pumice or zeolite, and about 10-25% by volume sand.

11. The stormwater filtration system of claim 10 wherein the media mixture further comprises water absorbent crystal material in an amount of less than 1% by volume.

12. The stormwater filtration system of claim 5 wherein the media mixture comprises coarse sand and peat granules.

13. The stormwater filtration system of claim 12 wherein the media mixture comprises about 85-95% by volume of coarse sand and about 5-15% by volume peat granules.

14. The stormwater filtration system of claim 1 wherein the filtration layer has a depth of about 6-30 inches and the adsorption layer has a depth of about 2-6 inches.

15. The stormwater filtration system of claim 1 wherein the filtration bed includes a drainage layer beneath the adsorption layer wherein the drainage layer comprises gravel.

16. The stormwater filtration system of claim 1 wherein the bay is a first bay of the vault and the vault includes a second bay alongside the first bay, the second bay including at least one stormwater filtration device and an inlet for receiving excess stormwater from the first bay.

17. The stormwater filtration system of claim 1 wherein the live plant matter is a tree and the filtration bed includes an upper layer formed by a plurality of permeable pavers disposed about a trunk of the tree.

18. A method for treating stormwater, the method comprising:
receiving stormwater into a treatment bay including a filtration bed having live plant material planted therein, wherein the filtration bed comprises a filtration layer overlying an adsorption layer wherein said adsorption layer comprises a phosphorus adsorptive granular media;
filtering some of the stormwater downward through the filtration bed; and
directing the stormwater filtered by the filtration bed away from the treatment bay.

19. The method of claim 18, wherein the phosphorus adsorptive granular media comprises expanded perlite thermally impregnated with activated alumina.

20. The method of claim 18 wherein the average particle size of the phosphorus adsorptive granular media is about 0.5 mm to about 12.5 mm.

21. The method of claim 18 wherein the filtration layer includes a media mixture which comprises about 7-13% by volume of pelletized leaf compost, about 60-80% by volume pelletized pumice or zeolite, and about 10-25% by volume sand.

22. The method of claim 18 wherein the filtration layer includes a media mixture which comprises about 85-95% by volume of coarse sand and about 5-15% by volume peat granules.

23. A stormwater filtration system comprising:
a vault forming a bay having a filtration bed with live plant matter therein, an inlet for delivering stormwater into the bay, an outlet flow system in a lower part of the bay for receiving stormwater filtered through the filtration bed and delivering the filtered stormwater out of the bay, wherein the filtration bed comprises a plurality of layers and an uppermost layer comprises permeable pavers.

24. The stormwater filtration system of claim 23 wherein the permeable pavers have a permeability of not less than 10 gallons per minute per square foot.

25. A stormwater filtration system comprising:
a vault forming a bay having a filtration bed with live plant matter therein, an inlet for delivering stormwater into the bay, an outlet flow system in a lower part of the bay for receiving stormwater filtered through the filtration bed and delivering the filtered stormwater out of the bay, and an absorption area comprising a phosphorus adsorptive granular media

26. The stormwater filtration system of claim 25 wherein the absorption area comprises a permeable sock.

27. The stormwater filtration system of claim 26 wherein the permeable sock is located in the outlet flow system.

28. The stormwater filtration system of claim 25 wherein the absorption area comprises a removable media polishing vessel.

29. The stormwater filtration system of claim 28 wherein the outlet flow system delivers filtered stormwater to the removable media polishing vessel.
